(19) United States
(12) Patent Application Publication
(10) Pub. No.: US 2011/0129758 A1
(43) Pub. Date: Jun. 2, 2011

(54) WATER ELECTROLYSIS APPARATUS AND WATER ELECTROLYSIS SYSTEM

(75) Inventors: Kazunari NAYA, Toda-city (JP); Kenji FUKUI, Taito-ku (JP)

(73) Assignee: WATERWARE INC., Tokyo (JP)

(21) Appl. No.: 13/023,050

(22) Filed: Feb. 8, 2011

(30) Foreign Application Priority Data
Sep. 5, 2008 (JP) 2008-228213

(51) Int. Cl. C02F 1/461; C25B 9/00; H01M 8/10; C25B 1/04

(52) U.S. Cl. 429/479; 204/275.1; 205/742

(57) ABSTRACT

A water electrolysis apparatus includes: a solid electrolyte film; an anode; a cathode; and a flow path. The solid electrolyte film includes a first surface and a second surface opposite side of the first surface. The anode is provided to contact with the first surface in a first surface side. The cathode is provided to be separated from the second surface in a second surface side. The flow path is provided between the second surface and the cathode. Water can flow through the anode. Electrolytic solution can flow through the flow path.

### CROSS-REFERENCE TO RELATED APPLICATIONS

The present application claims the benefit of Japanese patent application No. 2008-228213, filed in Japan on Sep. 5, 2008, the subject matter of which is hereby incorporated herein by reference.

### BACKGROUND OF THE INVENTION

1. Field of the Invention

The present invention relates to a water electrolysis apparatus and a water electrolysis system. More particularly, the present invention relates to a water electrolysis apparatus and a water electrolysis system, in which water is electrolyzed.

2. Description of Related Art

Conventionally, an electrolysis apparatus is known as a technique for electrolyzing water. The conventional electrolysis apparatus uses a sandwich structure in which one side of an ion conductive film (solid (polymer) electrolyte film) is in contact with an anode, and the other side of the ion conductive film is in contact with a cathode. That is, both sides of the ion conductive film are closely contacted with the anode and the cathode, respectively. When water is electrolyzed in the electrolysis apparatus with the above structure, hydrogen is generated on the cathode side, and oxygen is generated on the anode side. Thus, in order to release generated hydrogen and oxygen, it is essential to use the porous or reticular electrode as the cathode and the anode. One example of the above-mentioned structure is disclosed in Japanese Patent Publication No. JP-P 2004-353033A.

Japanese Patent Publication No. JP-P 2004-353033A discloses an assembly of a water electrolysis film and electrodes and a water electrolysis apparatus using the same. This assembly of the water electrolysis film and the electrodes includes a solid polymer electrolyte film, an oxygen electrode joined to one side of the solid polymer electrolyte film, and a hydrogen electrode joined to the other side of the solid polymer electrolyte film. The oxygen electrode includes: an iridium-plated porous sheet-shaped carbon material; and a coating layer of a mixture that contains carbon, which is applied to the surface of the sheet-shaped carbon material on the side in contact with the solid polymer electrolyte film, and resin for a solid polymer film. The hydrogen electrode includes: a porous sheet-shaped carbon material; a coating layer of a mixture that contains carbon, which is applied to the sheet-shaped carbon material, and resin for a solid polymer film; and a coating layer of a mixture that as compared with the above coating layer, further contains Pt (alloy) and/or Pt (alloy) holding carbon and resin for a solid polymer film. That is, this example uses the hydrogen electrode (cathode) and the oxygen electrode (anode), each of which mainly has the porous sheet-shaped carbon material.

However, the inventors have now discovered the following facts. In the foregoing structure, for example, when the portions in which the ion conductive film and the cathode are closely contacted with each other are observed in detail, there mix the portions in which the ion conductive film and the cathode are in contact with each other and the portions in which the ion conductive film and the cathode are not in contact with each other. For this reason, it is considered that the unbalance of electric fields occurs in the portions in which the ion conductive film and the cathode are closely contacted with each other. That is, it is considered that the portion in which the electric field is locally concentrated exists inside the ion conductive film. In this case, the concentration of the electric field causes a voltage loss to be increased inside the ion conductive film, the electric field efficiency to be decreased, and the electrolysis apparatus to be deteriorated.

The inventors have been studying the deterioration mechanism which occurs in the electrolysis apparatus with the conventional structure as mentioned above, and have now discovered that there are at least two kinds of the deterioration mechanism for the first time. In the first deterioration mechanism, among positive ions move inside the ion conductive film from the anode side, positive ions except hydrogen and alkali metal are precipitated in the electric field concentration portions on the cathode side, and the substances (mainly the metals) precipitated on the cathode side of the ion conductive film destroy the ion conductive film and hinder the ion conduction inside the ion conductive film. This deterioration occurs mainly during the operation of the electrolysis apparatus.

The second deterioration mechanism is such that hydrogen ions, which are generated on the anode and move inside the ion conductive film to the cathode and are liberated as the hydrogen on the cathode, move inside the ion conductive film from the cathode to the anode when the power source is turn-off (when the power is off), react with the anode, and consequently reduce the catalytic activation of the anode. This deterioration occurs mainly after the finish of the operation of the electrolysis apparatus.

Due to those two deterioration mechanisms, the phenomenon occurs in which the deterioration is progressed correspondingly to the operational time of the electrolysis apparatus (the first deterioration mechanism) and the deterioration is sharply progressed by the intermittent operation (the second deterioration mechanism). Also, it is considered that these two deterioration mechanisms occur in a solid polymer fuel cell which uses the reaction opposite to that of the above electrolysis, even though the cathode and the anode are opposed.

### SUMMARY

Therefore, an object of the present invention is to provide a water electrolysis apparatus and a water electrolysis system that can suppress a deterioration phenomenon occurring in an ion conductive film and an electrode, when water is electrolyzed.

Also, another object of the present invention is to provide a solid polymer fuel cell that can suppress a deterioration phenomenon occurring in an ion conductive film and an electrode, when hydrogen and oxygen are used to generate electric power.

This and other objects, features and advantages of the present invention will be readily ascertained by referring to the following description and drawings.

In order to achieve an aspect of the present invention, the present invention provides a water electrolysis apparatus including: a solid electrolyte film configured to include a first surface and a second surface opposite side of the first surface; an anode configured to be provided to contact with the first surface in a first surface side; a cathode configured to be provided to be separated from the second surface in a second surface side; and a flow path configured to be provided between the second surface and the cathode, wherein water can flow through the anode, and wherein electrolytic solution can flow through the flow path.

In order to achieve another aspect of the present invention, the present invention provides a water electrolysis system including: a water supplying unit configured to supply water; a electrolytic solution supplying unit configured to supply electrolytic solution; and a water electrolysis apparatus configured to receive the water and the electrolytic solution and perform electrolysis of the water, wherein the water electrolysis apparatus includes: a solid electrolyte film configured to include a first surface and a second surface opposite side of the first surface, an anode configured to be provided to contact with the first surface in a first surface side, a cathode configured to be provided to be separated from the second surface in a second surface side, and a flow path configured to be provided between the second surface and the cathode, wherein the water can flow through the anode, and wherein the electrolytic solution can flow through the flow path.

In order to achieve still another aspect of the present invention, the present invention provides a water electrolysis method including: supplying water to an anode provided to contact with a first surface of a solid electrolyte film, wherein the water flows through the anode; supplying electrolytic solution between a cathode provided to be separated from a second surface of the solid electrolyte film and the second surface; and applying a direct current power between the anode and the cathode.

In order to achieve yet still another aspect of the present invention, the present invention provides a solid polymer fuel cell including: a solid electrolyte film configured to include a first surface and a second surface opposite side of the first surface; an anode configured to be provided to contact with the first surface in a first surface side; a cathode configured to be provided to be separated from the second surface in a second surface side; and a flow path configured to be provided between the second surface and the cathode, wherein fuel can flow through the anode, and wherein oxidant and electrolytic solution can flow through the flow path.

According to the present invention, the deterioration phenomenon, which occurs in the ion conductive film and the electrode, can be suppressed when water is electrolyzed.

Also, according to the present invention, the deterioration phenomenon, which occurs in the ion conductive film and the electrode, can be suppressed when hydrogen and oxygen are used to generate electric power.

### BRIEF DESCRIPTION OF THE DRAWINGS

FIG. 1 is a block diagram showing a configuration of a water electrolysis system that includes a water electrolysis apparatus according to an embodiment of the present invention;

FIG. 2 is a schematically sectional view showing a configuration of the water electrolysis apparatus according to the embodiment of the present invention;

FIG. 3 is a schematically sectional view showing a configuration of the vicinities of the ion conductive film and the cathode in the conventional electrolysis apparatus;

FIG. 4 is a schematically sectional view showing a configuration of the vicinities of the ion conductive film and the cathode in the water electrolysis apparatus according to the embodiment of the present invention; and

FIG. 5 is a schematically sectional view showing another configuration of the water electrolysis apparatus according to the embodiment of the present invention.

### DESCRIPTION OF THE PREFERRED EMBODIMENTS

A water electrolysis apparatus and a water electrolysis system according to an embodiment of the present invention will be described below with reference to the attached drawings.

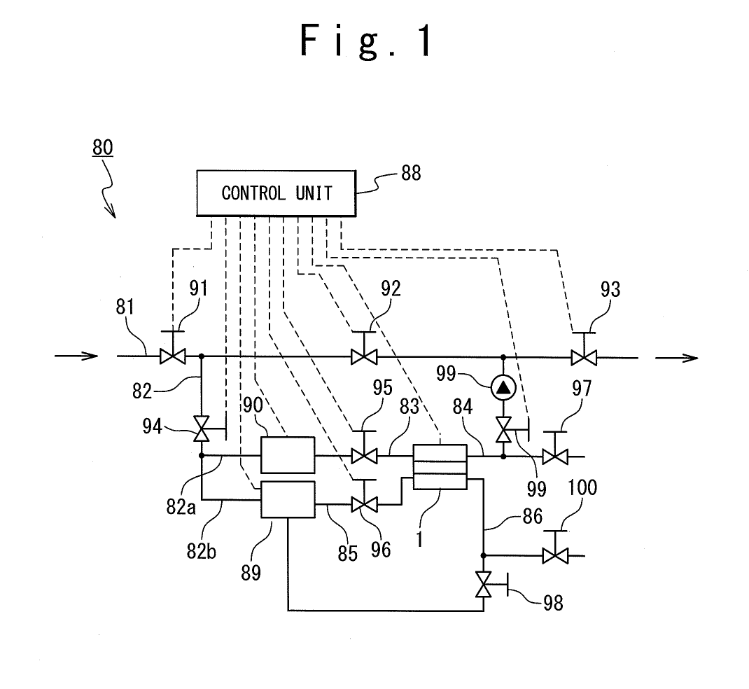

FIG. 1 is a block diagram showing a configuration of a water electrolysis system that includes a water electrolysis apparatus according to the embodiment of the present invention. A water electrolysis system 80 includes anion exchanger 90, an electrolytic solution supplier 89, a water electrolysis apparatus 1, a controller 88, pipes 82, 82a, 82b, 83 to 86, and valves 94 to 99. Arrows indicate directions of water flows.

In the present invention, to suppress deterioration phenomena in electric processing, not only water but also electrolytic solution are supplied to the water electrolysis apparatus 1 in which the water is electrolyzed. A method of supplying the electrolytic solution in the water electrolysis apparatus 1 and a function of the electrolytic solution will be described later in detail. This embodiment will be described below in detail.

The ion exchanger 90 includes an ion exchange resin filter (not shown) and is connected to the pipe 82a. The ion exchanger 90 removes predetermined impurities in water (e.g. tap water), which is supplied through the pipe 82a, by the ion exchange resin filter. The predetermined impurities are substances that have an influence on a water electrolysis process executed by a cell (which will be described later) in the water electrolysis apparatus 1. Mineral components such as calcium, magnesium and the like are exemplified as such substances. The ion exchange resin filter is exemplified as a positive ion exchange resin filter (salt type: e.g. Na type). Moreover, in addition thereto, in order to remove chlorine, this may have at least one of an activated carbon filter, a calcium sulfite filter and a negative ion exchange resin filter. The ion exchanger 90 supplies the water from which the impurities are removed, through the pipe 83 (and the valve 95) to the water electrolysis apparatus 1.

In this embodiment, an object of the ion exchange resin filter is at least to minimize contamination and breakage of the cell and to stabilize the original hydrogen ion level of water. It is not necessary to remove other substances contained in the water as much as possible. For this reason, it is enough to use at least one kind of filter, which can simplify the structure and configuration of the ion exchanger 90. However, an apparatus for removing other substances contained in the water as much as possible may be further added.

The electrolytic solution supplier 89 generates electrolytic solution by using water supplied through the pipe 82b. For example, the electrolytic solution supplier generates the electrolytic solution by adding electrolyte material preliminarily stored in a tank or high concentration electrolytic solution to the supplied water by a predetermined amount. The electrolytic solution supplier 89 supplies the generated electrolytic solution through the pipe 85 (and the valve 96) to the water electrolysis apparatus 1. The detail of the electrolytic solution will be described later. Incidentally, the tank or the like may be placed at an external different place. Also, the portion in which the high concentration electrolytic solution is added by the predetermined amount maybe the portion except the electrolytic solution supplier 89. For example, the high concentration electrolytic solution is may be supplied between a cathode and an ion conductive film (which will be described later) inside the water electrolysis apparatus 1.

When the electrolytic solution is circulated, for example, it is possible to use a circulation route composed of the electrolytic solution supplier 89—the pipe 85 (the valve 96)—the water electrolysis apparatus 1—the pipe 86 (the valve 98)—the electrolytic solution supplier 89. In this case, for example, an anion exchange resin filter in which a particular anion such as chlorine and the like is absorbed and a cation exchange resin filter in which a particular cation such as sodium and the like is absorbed are arranged in the electrolytic solution supplier 89. Consequently, composition change in the electrolytic solution can be relaxed, thereby decreasing an exchange frequency of the electrolytic solution. This is very effective when the water supplied to an anode is not pure (soft water, tap water, freshwater, seawater and the like).

As another type of the electrolytic solution supplier 89, for example, a method is considered which arranges a tank storing the electrolytic solution at a different place and supplies the electrolytic solution between the cathode and the ion conductive film in the water electrolysis apparatus 1 by using a pump.

In the water electrolysis apparatus 1, the side to which the water for the anode is supplied is connected to the pipe 83, and the side from which it is exhausted is connected to the pipe 84, respectively. In addition, the side to which the electrolytic solution for the cathode is supplied is connected to the pipe 85, and the side from which it is exhausted is connected to the pipe 86, respectively. In the water electrolysis apparatus 1, the water which is treated in the ion exchanger 90 and from which the predetermined impurities are removed is supplied to the anode side, and the electrolytic solution which is treated in the electrolytic solution supplier 89 and has a predetermined concentration is supplied to the cathode side, respectively. Then, the electric processing (electrolysis) in which electric power is applied to the water is executed. The water molecule is dissolved by this electrolysis. Consequently, product materials are generated correspondingly to the value of the electric power applied to the water. For example, when the electric power (voltage, current) applied in the usual electrolysis is applied, oxygen gas is generated on the anode side and hydrogen gas is generated on the cathode side. On the other hand, when the higher electric power (higher voltage, higher current) than the electric power applied in the usual electrolysis is applied, radical oxygen water that richly contains radical molecules is generated on the anode side. The radical molecule is exemplified as active oxygen, hydrogen peroxide, ozone and hydroxyl radical. Also, hydrogen gas or hydrogen radical is generated on the cathode side.

The pipe 81 supplies water (e.g. tap water). The valve 91 is placed in the course of the pipe 81 and controls the water flow in the pipe 81. The valve 92 and the valve 93 are placed in the course of the pipe 81 and control the flow of the water that bypasses the water electrolysis system 80. The pipe 82 is branched from the pipe 81 between the valve 91 and the value 92 and connected to the valve 94. The valve 94 controls the supply of the water to the water electrolysis system 80. Through the pipe 82a, the valve 94 and the ion exchanger 90 are connected. Through the pipe 82b, the valve 94 and the electrolytic solution supplier 89 are connected. Through the pipe 83 and the valve 95, the ion exchanger 90 and the water electrolysis apparatus 1 (the anode side) are connected. Through the pipe 85 and the valve 96, the electrolytic solution supplier 89 and the water electrolysis apparatus 1 (the cathode side) are connected. The pipe 84 is connected to the water electrolysis apparatus 1 (the anode side), and the water (of the anode side) can be exhausted through the pipe 84 and the valve 97, and also the water can be exhausted through the pipe 84 and the valve 99 and a check valve to the pipe 81. The pipe 86 is connected to the water electrolysis apparatus 1 (the cathode side), and the electrolytic solution (of the cathode side) can be exhausted through the pipe 86 and the valve 100, and also the electrolytic solution can be circulated through the pipe 86 and the valve 98 to the electrolytic solution supplier 89.

The controller 88 controls the operations of the valves 91 to 100, the ion exchanger 90, the electrolytic solution supplier 89 and the water electrolysis apparatus 1. However, all of them may not be controlled by the controller 88, and they may be controlled by a plurality of control units (not shown). Also, all of them can be manually controlled without any installation of the controller 88.

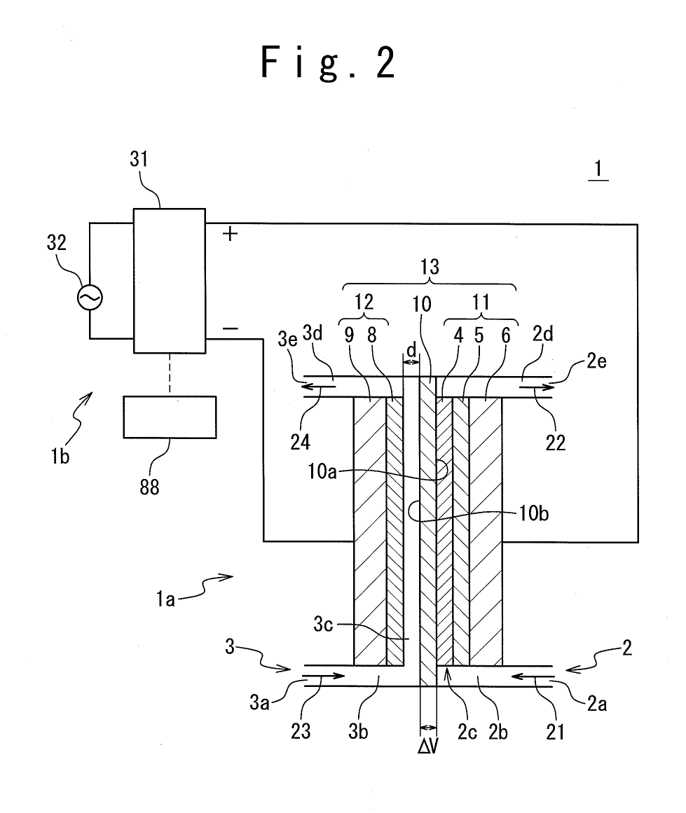

The water electrolysis apparatus 1 is further described below. FIG. 2 is a schematically sectional view showing a configuration of the water electrolysis apparatus according to the embodiment of the present invention. The water electrolysis apparatus 1 includes a power source unit 1b and a water electrolysis apparatus body 1a. The operation of the power source unit 1b is controlled by the controller 88. Arrows in the water electrolysis apparatus body 1a indicate the directions of the flows of the water and the like. Here, the water electrolysis apparatus for not carrying out the usual electrolysis but carrying out the electrolysis to generate radical oxygen water is described. However, if the applied electric power is changed to be decreased, it will serves as the water electrolysis apparatus for carrying out the usual electrolysis.

The power source unit 1b supplies electric power to the water electrolysis apparatus body 1a. The power source unit 1b includes an alternating current power source 32 and a converter 31. The alternating current power source supplies predetermined alternating current electric power. The alternating current power source 32 is exemplified as a system power source (a power source supplied from a commercial power distribution network possessed by an electric power corporation, e.g. 100V or 200V). The alternating current electric power is supplied from the alternating current power source 32 to the converter 31, which converts it into predetermined direct current electric power. Then, the direct current electric power is supplied to the water electrolysis apparatus body 1a. As for the supplied direct current electric power, for example, a voltage is in the range from 4 to 20 V, and a current for each unit area of the cell in the water electrolysis apparatus body 1a is in the range from 0.1 to 5 A/cm². These voltage and current are greater than those of the direct current electric power of the usual water electrolysis. Thus, ozone and active oxygen are easily generated by the reaction in the anode. Thus, in this case, the water electrolysis apparatus 1 generates radical oxygen water.

In the water electrolysis apparatus body 1a, water 21 treated in the ion exchanger 90 is supplied to the anode side, and electrolytic solution 23 treated in the electrolytic solution supplier 89 is supplied to the cathode side, respectively. Then, with the electric power supplied from the power source unit 1b, the water 21 is electrically treated (electrolysis) and sent as radical oxygen water 22 to the outside. The water electrolysis apparatus body 1a includes an anode side flow path 2, a cathode side flow path 3 and a cell 13. The cell 13 includes an ion conductive film 10, an anode unit 11 and a cathode unit 12.

The anode side flow path 2 includes an opening 2a, flow paths 2b, 2c and 2d and an opening 2e. The opening 2a is formed on the outer surface of the water electrolysis apparatus body 1a and connected to the pipe 83. The opening 2a introduces the water 21 treated in the ion exchanger 90 into the water electrolysis apparatus body 1a. It is exemplified as the end of the pipe. The flow path 2b is formed from the opening 2a toward an end of the anode unit 11 inside the water electrolysis apparatus body 1a. It is exemplified as the pipe. The flow path 2b supplies the water 21 supplied through the opening 2a to the anode unit 11. The flow path 2c is a hollow portion inside an anode 4 and a Ti wire mesh 5 (which will be described later) in the anode unit 11. That is, the supplied water 21 flows through the hollow portion inside the anode 4 and the Ti wire mesh 5, which serve as the flow path 2c. However, between the anode 4 and the ion conductive film 10, there exist contact portions and contactless portions and these portions are in the mixed situation. The flow path 2d is formed from another end of the anode unit 11 toward the outer surface of the water electrolysis apparatus body 1a. It is exemplified as the pipe. The radical oxygen water 22 treated in the anode unit 11 is sent to the opening 2e. The opening 2e is formed on the outer surface of the water electrolysis apparatus body 1a and connected to the pipe 84. The opening 2e sends water 22 from the flow path 2d outside the water electrolysis apparatus body 1a. It is exemplified as an end of the pipe.

The cathode side flow path 3 includes an opening 3a, flow paths 3b, 3c and 3d and an opening 3e. The opening 3a is formed on the outer surface of the water electrolysis apparatus body 1a and connected to the pipe 85. The opening 3a introduces the electrolytic solution 23 treated in the electrolytic solution supplier 89 to the water electrolysis apparatus body 1a. It is exemplified as the end of the pipe. The flow path 3b is formed from the opening 3a toward an end of the cathode unit 12 inside the water electrolysis apparatus body 1a. It is exemplified as the pipe. The flow path 3b supplies the electrolytic solution 23 supplied through the opening 3a to the cathode unit 12. The flow path 3c is a gap portion (partially including a gap portion inside the cathode 8) formed between the cathode 8 in the cathode unit 12 and the ion conductive film 10 (which will be described later). That is, the supplied electrolytic solution 23 flows through the gap portion between the cathode 8 and the ion conductive film 10 as the flow path 3c. Here, there is no contact portion between the cathode 8 and the ion conductive film 10, and the cathode 8 and the ion conductive film 10 are not in contact with each other, perfectly. The flow path 3d is formed from another end of the cathode unit 12 toward the outer surface of the water electrolysis apparatus body 1a. It is exemplified as the pipe. The flow path 3d sends electrolytic solution 24 passed through the flow path 3c to the opening 3e. The opening 3e is formed on the outer surface of the water electrolysis apparatus body 1a and connected to the pipe 86. The opening 3e sends the electrolytic solution 24 from the flow path 3d outside the water electrolysis apparatus body 1a. It is exemplified as the end of the pipe.

The cell 13 is placed inside the water electrolysis apparatus body 1a. The water 21 supplied from the ion exchanger 90 is supplied through the anode side flow path 2 to the anode unit 11, and the electrolytic solution 23 supplied from the electrolytic solution supplier 89 is supplied through the cathode side flow path 3 to the cathode unit 12, respectively. Then, with the direct current electric power supplied from the power source unit 1b to the anode unit 11 and the cathode unit 12, the water 21 inside the anode unit 12 is electrically treated to generate the radical oxygen water 22. The cell 13 includes the ion conductive film 10, the anode unit 11 and the cathode unit 12, as mentioned above.

The ion conductive film (the solid electrolyte film) 10 is a proton conductive film (an ion exchange film of an H-type) that has a first surface 10a on the anode side and a second surface 10b on the cathode side. As a proton conductive film, a strong-acid cation exchange resin of a sulfonic acid type of a solid polymer film, and a perfluorosulfonic acid polymer film are exemplified. For example, it is exemplified as a Nafion film (registered trademark: made by E. I. du Pont de Nemours and Company). The film thickness is, for example, 0.2 mm.

The anode unit 11 is provided to contact with one surface 10a of the ion conductive film 10, and the water 21 can flow through it. The anode unit 11 functions as the electrode to which the direct current electric power from the power source unit 1b is supplied. The anode unit 11 includes a first electrode unit 6, a second electrode unit 5 and an anode 4. The first electrode unit 6 is connected to a positive electrode of the converter 31, when the converter 31 supplies the direct current electric power to the cell 13. The first electrode unit 6 is a conductive plate and is exemplified as a Ti (titanium) plate. The second electrode unit 5 is provided such that one surface is closely attached to the first electrode unit 6 and the other surface is closely attached to the anode 4. The second electrode unit 5 is a conductive porous body or conductive mesh through which the water 21 can be transmitted. It is exemplified as a Ti (titanium) wire mesh. The metal wire mesh is, for example, 0.4 to 0.6 mmφ and 40 meshes. The anode 4 is provided such that one surface is closely attached to the second electrode unit 5 and the other surface is closely attached to one surface 10a of the ion conductive film 10. The anode 4 is a porous body or mesh through which the water 21 can be transmitted and which is conductive and has a catalyst function of an electrolysis reaction. It is exemplified as a Pt (platinum) wire mesh. The metal wire mesh is for example, 0.05 to 0.1 mmφ and 80 meshes.

The cathode unit 12 is provided to be separated from (not to be in contact with) the other surface 10b of the ion conductive film 10. The supplied electrolytic solution 23 can flow through the flow path 3c that is (a gap) between the cathode unit 12 and the ion conductive film 10. The cathode unit 12 includes an electrode unit 9 and the cathode 8. The electrode unit 9 is connected to a negative electrode of the converter 31 when the converter 31 supplies the direct current electric power to the cell 13. The electrode unit 9 is a conductive plate and is exemplified as a Ti (titanium) plate. The cathode 8 is provided such that one surface is closely attached to the electrode unit 9 and the other surface is separated from the other surface 10b of the ion conductive film 10. The supplied electrolytic solution 23 can flow through the flow path 3c that is (a gap) between the cathode 8 and the ion conductive film 10. The cathode 8 is a porous body or mesh through which the electrolytic solution 23 can be transmitted and which is conductive and has a catalyst function of an electrolysis reaction. It is exemplified as a Pt (platinum) wire mesh. The metal wire mesh is for example, 0.05 to 0.1 mmφ and 80 meshes.

When the metal wire mesh (e.g. Ti wire mesh) is used as the second electrode unit 5 and also the metal wire mesh (e.g. Pt wire mesh) is used as the anode 4, the Ti wire mesh and the Pt wire mesh overlap with each other and form a narrow water path. For this reason, when the supplied water 21 is rapidly passed through the metal wire mesh, which serves as contact portions between the second electrode unit 5 and the anode 4 and the ion conductive film 10, this results in the turbulent state. On the other hand, when the metal wire mesh (e.g. Pt wire mesh) is used as the cathode 8, the Pt wire mesh forms the narrow flow path. For this reason, the portion within the metal wire mesh and the portion between the ion conductive film 10 and the cathode 8 are filled with the supplied electrolytic solution 23. In such a state, ozone and the like, which are generated on the anode side, can be efficiently dissolved in the water by the electrolysis that results from the supply of the electric power between the anode unit 11 and the cathode unit 12. That is, when the supplied water 21 is passed through the vicinity of the anode 4, the water 21 is efficiently electrolyzed and thereby becoming the radical oxygen water 22 in which the ozone and the oxygen are dissolved.

When water is used as solvent, the electrolytic solution 23 is exemplified as strong acid such as hydrochloric acid, sulfuric acid, nitric acid, sulfurous acid and the like, and salt between strong acid and alkali metal such as sodium chloride, sodium sulfate, sodium nitrate and the like. In particular, aqueous solution of salt between strong acid and alkali metal such as at least one of the sodium chloride, the sodium sulfate, the sodium nitrate and the like is preferable. Also, it is effective to use chloride. Sulfite and the like can be also used. However, it is preferable not to use strong acid when corrosion of a pipe or the like becomes problematic.

Also, when at least one of a chemical compound (e.g. boric acid, borax) containing a thirteenth group element (a boron group) and a chemical compound (e.g. phosphoric acid, phosphate) containing a fifteenth group element (a nitrogen group) is added to the electrolytic solution 23, an electric field efficiency is increased, which is preferable. This is because a part of those substances migrates to the anode side so that it has an effect of promoting the electrolysis reaction on the surface of the anode 4 and suppressing the deterioration in the anode 4. For example, when the anode 4 is made of Pt, boron is slightly doped on the Pt oxide on the surface of the anode 4 so that a property of a P-type semiconductor is added to the Pt oxide. This fact implies that the Pt oxide functions as the strongly oxidizing catalyst and has an effect of improving the electrolysis efficiency of ozone generation. Also, when the anode 4 is made of boron-doped diamond, there is a problem that the long-time electrolysis causes boron on the surface to be dropped, which reduces the conductivity of the electrode surface. However, since the substance including boron is added to the electrolytic solution, a situation in which boron exists slightly around the anode 4 is created, which can avoid boron from being dropped.

Moreover, acid (e.g. strong Acid, acetic acid, citric acid, ascorbic acid) forming a metal complex is added to the electrolytic solution 23, a precipitation phenomenon of substances on the surface of the cathode 8 can be suppressed, which is preferable.

The longer a distance d between the cathode 8 and the ion conductive film 10 is, the less the deterioration in the ion conductive film 10 is. However, when the distance d is excessively long, the electric power loss is increased because of the limit of the conductivity of the electrolytic solution. Thus, as the lower limit, at least a distance which leads to a potential difference of 1/10 of a potential difference ΔV generated between the cathode side and anode side of the ion conductive film 10 is preferable, in view of the effect of the deterioration protection and the like. On the other hand, as the upper limit, a distance which leads to a potential difference equal to four times of the potential difference ΔV is preferable, in view of the limit of the conductivity of the electrolytic solution.

For example, when sodium chloride aqueous solution is used as the electrolytic solution, the distance d between the cathode 8 and the ion conductive film 10 is as follows. When the electrolytic solution 23 is the sodium chlorine aqueous solution of 10 weight %, its conductivity is 121 mS/cm. This value is approximately equal to a conductivity of the ion conductive film 10 of, for example, Nafion (registered trademark of E.I. du Pont de Nemours and Company) and the like. Thus, when the electrolytic solution 23 of the concentration of this degree is used, the distance d between the ion conductive film 10 and the cathode 8 can be set to 0.1 to 4 times of the film thickness of the ion conductive film 10. That is, when the film thickness of the ion conductive film 10 is set to 0.2 mm, the distance d between the ion conductive film 10 and the cathode 8 is a value between 0.02 mm and 0.8 mm.

As a method of forming the gap (the flow path 3c) between the cathode 8 and the ion conductive film 10, for example, a method is considered in which the anode unit 11 and the ion conductive film 10 are integrally held by a housing of the water electrolysis apparatus body 1a while the cathode unit 12 is held by the housing of the water electrolysis apparatus body 1a so as to be separated from the ion conductive film 10. Also, between the cathode 8 and the ion conductive film 10, for example, a pressure, which is higher than that of the water 21 on the anode side, is applied to the electrolytic solution 23 on the cathode side. Thus, the attaching property between the ion conductive film 10 and the anode 4 can be secured while the distance d between the ion conductive film 10 and the anode 4 can be kept constant. That is, the anode 4 and the ion conductive film 10 may be, for example, thermally compressed and bonded in order to secure the attaching property between the anode 4 and the ion conductive film 10. However, even in this situation, the cathode side of the ion conductive film 10 is structurally weak. Hence, a constant pressure is applied to the cathode side, and the ion conductive film 10 is pushed against the anode 4.

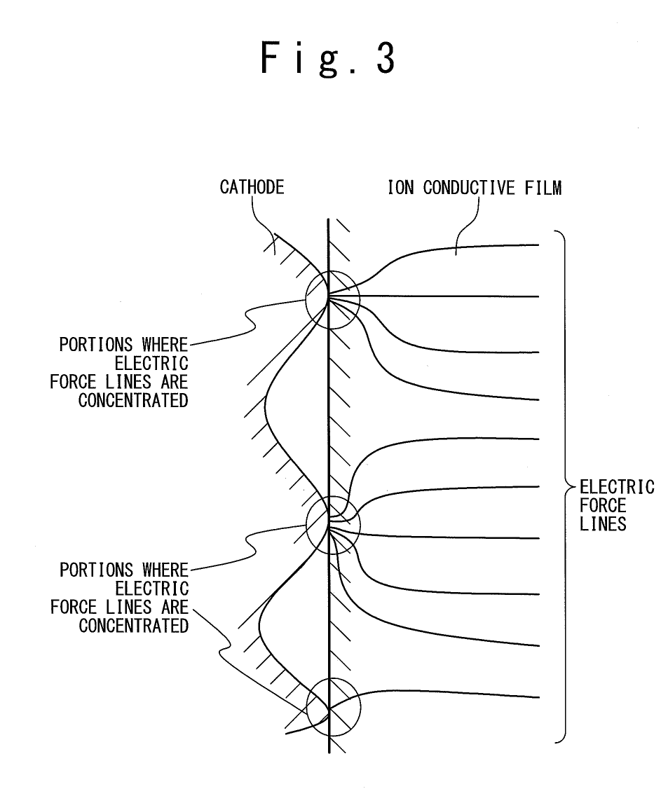

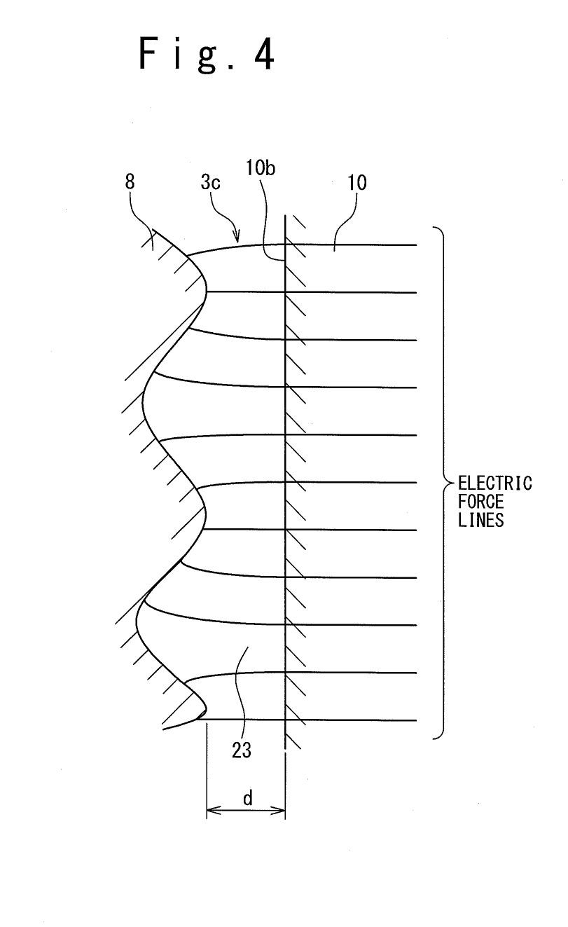

Next, the technical effects of the water electrolysis apparatus according to the embodiment will be described below. FIG. 3 is a schematically sectional view showing a configuration of the vicinity of an ion conductive film and a cathode in the conventional electrolysis apparatus. FIG. 4 is a schematically sectional view showing a configuration of the vicinity of the ion conductive film and the cathode in the water electrolysis apparatus according to the embodiment of the present invention

As shown in FIG. 3 in which the vicinity of the ion conductive film and the cathode are enlarged, in the case of the conventional structure, even though the cathode is closely attached to the ion conductive film, there exist portions where the ion conductive film and the cathode contact with each other and portions where they do not contact with each other. This is because in order to release hydrogen generated on the cathode, the cathode should not have a smooth surface for being closely attached to the ion conductive film. Then, when the electrolysis (electrolyzing action) is carried out in this state, the electric fields are concentrated in the portions where the cathode and the ion conductive film contact with each other (the portions where electric force lines are concentrated in FIG. 3).

To this situation, it is difficult to say that the ion conductive film is effectively used. The ion flows are also concentrated to the contact portions, as represented by those electric force lines. Thus, this causes the voltage loss and the drop in the efficiency. In addition, stress and vibration which result from hydrogen micro babbles generated on the surface of the cathode are concentrated, thereby causing the ion conductive film to be damaged. Moreover, the most serious problem lies in the impurities precipitated on boundaries at the contact portions. These impurities are ions of metal kinds contained in water supplied to the anode and ions eluted from the anode and the like. Since the substances precipitated on the boundaries are grown along the electric force lines inside the ion conductive film, they destroy the ion conductive film. Also, since they disturb movements of ions, they cause the drop in the efficiency.

The above problems occur mainly during the electrolysis. However, in the conventional electrolysis apparatus, another problem occurs even after the completion of the electrolysis. That is, when the electrolysis is stopped and the power source is shut off (when the power source is turned off), hydrogen ions existing near the cathode and hydrogen ions existing inside the ion conductive film are moved to the anode side. Then, since the moved hydrogen ions act with the anode, the catalyst activation of the anode is reduced.

On the other hand, as shown in FIG. 4, in this embodiment, the cathode 8 is separated from the ion conductive film 10, and the flow path 3c between them is filled with the electrolytic solution 23. In such structure, the electric fields inside the ion conductive film 10 become substantially uniform. This is because portions where the electric fields are concentrated are moved into the electrolytic solution 23. This effect varies on the basis of the conductivity of the electrolytic solution 23 and the distance d between the cathode 8 and the ion conductive film 10. However, when the distance d satisfies the condition of “the distance that leads to the potential difference of 1/10 or more of the potential difference generated in the ion conductive film 10 at the time of the electrolysis”, the concentration of the electric fields is relaxed inside the ion conductive film 10. Under such condition, densities of ions moved inside the ion conductive film 10 become substantially uniform, which can minimize the voltage loss in the ion conductive film 10.

Also, since the concentration of the electric fields near the cathode 8 is relaxed, there is no case that the substances precipitated on the surface of the cathode 8 apply the stress to the ion conductive film 10. In addition, there is no case that the substances precipitated on the surface of the cathode 8 are inserted into the ion conductive film 10. Moreover, when the electrolytic solution 23 includes the substances that form the complex, the precipitation itself of the substances on the surface of the cathode 8 is suppressed.

Moreover, in the case of the structure in which the electrolytic solution 23 exists between the cathode 8 and the ion conductive film 10, it is known that, when the electrolysis is carried out, slight anions inside the electrolytic solution 23 migrate through the ion conductive film 10 and move to the anode side. The slight anions act to relax the contact unbalance between the surfaces of the ion conductive film 10 and the anode 4. Moreover, these slight anions, since propelling the electrolysis reaction on the surface of the anode 4, greatly contribute to the improvement of the electrolysis efficiency. Moreover, these slight anions suppress the damage of the ion conductive film 10 near the anode 4. This effect also contributes to the suppression of the deterioration.

Moreover, when the power source is shut off (when the power source is turned off), hydrogen ions near the cathode 8 are trapped by anions inside the electrolytic solution 23. For this reason, hydrogen ions are never moved into the ion conductive film 10. In addition, even hydrogen ions inside the ion conductive film 10 are trapped by anions inside the ion conductive film 10. Thus, the number of hydrogen ions moved to the anode side is much reduced. Thus, the reaction of the anode 4 with hydrogen is greatly suppressed. Hence, the catalyst activation of the anode 4 is kept even when the power source is shut off.

Due to the above effects, the deterioration in the ion conductive film 10 can be minimized, and the electric field effect can be improved. As a result, the life and efficiency of the water electrolysis apparatus are greatly improved.

An operation of the water electrolysis apparatus according to the embodiment of the present invention will be described below. Here, not the usual electrolysis but the water electrolysis for generating the radical oxygen water is described. However, changing the applied electric power to the small value leads to carrying out for the usual electrolysis.

With reference to FIG. 1, the valves 91, 93, 94, 95, 96, 98 and 99 are opened. The valve 92 is opened at the opening degree so that water passing through the valve 92 can be mixed with radical oxygen water passing through the valve 99 at a desirable rate.

Tap water after flowing through the pipes 82, 82a is supplied to the ion exchanger 90. The ion exchanger 90 removes substances, which have influence on electrical processing of water that is carried out by the cell 13 in the water electrolysis apparatus 1, from the tap water. The water 21 treated in the ion exchanger 90 is supplied through the pipe 83 to the anode side of the water electrolysis apparatus 1. On the other hand, tap water after flowing through the pipes 82, 82b is supplied to the electrolytic solution supplier 89. The electrolytic solution supplier 89 uses the tap water and generates the electrolytic solution 23. The electrolytic solution 23 generated in the electrolytic solution supplier 89 is supplied through the pipe 85 to the cathode side of the water electrolysis apparatus 1.

With reference to FIG. 2, the water 21 treated in the ion exchanger 90 flows through the flow path 2b of the water electrolysis apparatus 1 and is supplied to the anode unit 11. The water 21 flows through the second electrode unit 5 and the anode 4. On the other hand, the electrolytic solution 23 generated in the electrolytic solution supplier 89 flows through the flow path 3b of the water electrolysis apparatus 1 and is supplied to the cathode unit 12. The electrolytic solution 23 flows through the cathode 8 and the flow path 3c. The converter 31 in the power source unit 1b supplies a predetermined direct current electric voltage between the anode unit 11 and the cathode unit 12. As a result, the electrolysis reaction is carried out between the cathode 8, the ion conductive film 10 and the anode 4. With the electrolysis reaction, on the anode side, the large quantities of ozone and active oxygen are generated as compared with oxygen gas. As a result, on the anode side, the radical oxygen water 22 is generated, which richly contains radical molecules such as active oxygen, hydrogenperoxide, ozone and hydroxyl radical. The radical oxygen water 22 is sent through the flow path 2d to the outside (the pipe 84) of the water electrolysis apparatus 1. Also, hydrogen gas or hydrogen radical is generated inside the electrolytic solution on the cathode side.

As shown in FIG. 4, in this electrolysis action, since the cathode 8 is separated from the ion conductive film 10, the electric fields inside the ion conductive film 10 become substantially uniform. Thus, the densities of the ions moved inside the ion conductive film 10 becomes substantially uniform, and the voltage loss in the ion conductive film 10 can be minimized. As a result, since the concentration of the electric fields near the cathode 8 is also relaxed, the substances are not precipitated on the surface of the ion conductive film 10. Thus, it is possible to protect the ion conductive film 10 from being damaged and protect the ion conduction from being disturbed. Moreover, the slight anions inside the electrolytic solution 23 propel the electrolysis action on the surface of the anode 4 and suppress the ion conductive film 10 from being damaged near the anode 4. Moreover, when the electrolysis is carried out, the slight anions are known to migrate through the ion conductive film 10 and also move to the anode side. These slight anions act to relax the contact unbalance between the ion conductive film 10 and the surface of the anode 4.

With reference to FIG. 1, the radical oxygen water 22 passing through the pipe 84 and the valve 99 is mixed with water of the pipe 81, which bypasses the ion exchanger and the water electrolysis apparatus 1. Then, the radical oxygen water 22 having a desirable concentration is sent from the valve 93. Incidentally, the radical oxygen water 22 can be also used in its original state through the valve 97, without being mixed with water in the pipe 81. The exhausted electrolytic solution 24 used in the cathode unit 12 of the water electrolysis apparatus 1 is circulated through the pipe 86 to the electrolytic solution supplier 89 and re-used therein. However, it may be exhausted through a valve 100 to the outside.

When the power source of the water electrolysis apparatus 1 is shut off (the power source is turned off) after the water electrolysis, hydrogen ions near the cathode 8 are trapped by anions inside the electrolytic solution 23. Thus, the hydrogen ions are not moved into the ion conductive film 10. In addition, hydrogen ions inside the ion conductive film 10 are also trapped by anions inside the ion conductive film 10. Thus, the number of hydrogen ions moved to the anode side is much reduced. Hence, since the reaction of the anode 4 with hydrogen is greatly suppressed, the catalyst activation of the anode 4 is kept even when the power source is shut off.

As mentioned above, the water electrolysis system according to the embodiment of the present invention can be operated.

The water electrolysis system of the present invention has the structure that the cathode is not closely attached to the ion conductive film, it is arranged separately from the surface of the ion conductive film and a space between the cathode and the ion conductive film is filled with the electrolytic solution. The employment of such structure enables the portions where the electric fields are easily concentrated (the cathode surface) to be separated from the ion conductive film. Thus, it is possible to protect the substances from being precipitated inside the ion conductive film, and it is also possible to protect the ion conductive film from being destroyed and protect the ion conduction from being disturbed.

Also, when the power source is shut off (when the power source is turned off), hydrogen ions existing near the cathode are trapped by anions in the electrolytic solution, and hydrogen ions existing inside the ion conductive film are trapped by anions in the electrolytic solution that is diffused inside the ion conductive film. Thus, it is possible to protect hydrogen ions from being moved to the anode side, and it is possible to make the reaction between the anode and hydrogen ions difficult. Hence, the deterioration in the anode can be suppressed, thereby enabling the stable operation for a long time.

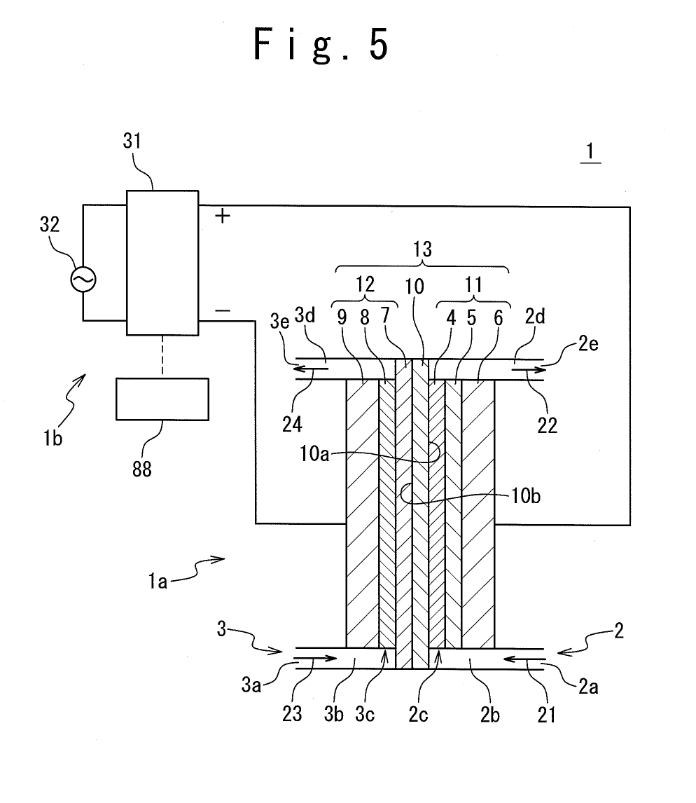

In the above-mentioned embodiment, only the electrolytic solution 23 exists between the cathode 8 and the ion conductive film 10. However, the present invention is not limited to such an example. That is, the nonconductive member containing the electrolytic solution may be included between the cathode 8 and the ion conductive film 10. FIG. 5 is a schematically sectional view showing another configuration of the water electrolysis apparatus according to the embodiment of the present invention. This water electrolysis apparatus 1 is basically equal to the water electrolysis apparatus 1 in FIG. 2. However, the configuration of FIG. 5 differs from that of FIG. 2 in that a nonconductive member 7 is provided between the cathode 8 and the ion conductive film (the flow path 3c).

The nonconductive member 7 is placed between the cathode 8 and the ion conductive film 10 (the flow path 3c) and made of a nonconductive material. The electrolytic solution 23 can flow through the nonconductive member 7. The nonconductive member 7 is exemplified as a porous body or mesh-shaped body. As the nonconductive member 7, for example, sponge, cotton and the like may be used. It is preferable for the nonconductive member 7 to be elastic. In this case, the water electrolysis apparatus 1 can have a structure in which the elastic nonconductive member 7 is sandwiched between the ion conductive film 10 and the cathode 8, and the elastic force of the nonconductive member 7 pushes the ion conductive film 10 against the anode 4, instead the pressure higher than that of the water 21 on the anode side is applied to the electrolytic solution 23 on the cathode side.

Also, the electrolytic solution 23 may be contained in the sponge or cotton as the nonconductive member 7. Moreover, the water electrolysis apparatus 1 may have a structure in which a tank for storing the electrolytic solution 23 is further placed on the outside and the electrolytic solution 23 is circulated by a pump. With such design, the composition change in the electrolytic solution 23 is reduced, and the supplement and exchange of the electrolytic solution 23 are made easy.

Moreover, instead of the sponge or the cotton, for example, gel substance maybe used. Then, even if a material in which the electrolytic solution is contained in the gel substance is used, the similar effect can be obtained.

The electrolytic solution 23 may include ion liquid containing the electrolytic solution or may be a gel substance containing the ion liquid.

In this embodiment, as for the radical oxygen water generated by using tap water serving as water of a raw material, the amount of radicals contained therein is very large as cannot be seen in the conventional technique. For example, the amount is approximately 10¹⁷/L or more. For this reason, even if about 20% to 30% is added to the tap water serving as the water of the raw material, its effect (e.g. bactericidal effect) can be checked. A technique for reducing the concentration of the electrolyzed water and applying it such as a dilution application is not confirmed in the conventional electrolysis water because of its nature. However, in the radical oxygen water according to the present invention, the use environment such as the dilution application can be attained as mentioned above. Here, when the radical oxygen water is diluted with water, the action in which the radical oxygen water is returned to original (primary) water becomes fast, correspondingly to its dilution amount. The radical oxygen water generated according to the present invention is controlled to keep a neutral region. However, when an oxidation-reduction potential (ORP) is increased to 1040 mV or more, the hydrogen ion concentration of the radical oxygen water is slightly inclined to the oxidation trend by the oxidation property of the radical molecules. That is, pH is approximately between 6.0 and 7.5.

The technique of this embodiment can be applied to the electrolysis apparatus for electrolyzing the usual water, as mentioned above. In addition, it can be similarly applied to the electric power generation of a fuel battery whose reaction is opposite to the electrolysis. That is, when the technique of this embodiment is applied to the solid polymer fuel cell that uses the reaction opposite to the electrolysis, it can similarly suppress the deterioration phenomenon occurring even in the solid polymer fuel cell. In that case, for example, in the water electrolysis apparatus body 1a in FIG. 2, the oxidant (e.g. oxygen) and the electrolytic solution are supplied to the side (the flow path 3c) of the cathode unit 12, and the fuel (e.g. hydrogen gas, hydrogen gas+water) is supplied to the side of the anode unit 11, respectively, and they are heated to predetermined temperatures, as necessary. Then, hydrogen gas of the anode unit 11 is changedtohydrogen ions and moved to the side of the cathode unit 12 inside the ion conductive film 10. In this case, the cathode unit 12 becomes a cathode unit 12 of the solid polymer fuel cell (the cathode 8 is a cathode 8 of the solid polymer fuel cell), and the anode unit 11 becomes an anode unit 11 of the solid polymer fuel cell (the anode 4 is an anode 4 of the solid polymer fuel cell).

It is apparent that the present invention is not limited to the above embodiment, but may be modified and changed without departing from the scope and spirit of the invention.

Although the present invention has been described above in connection with several exemplary embodiments thereof, it would be apparent to those skilled in the art that those exemplary embodiments are provided solely for illustrating the present invention, and should not be relied upon to construe the appended claims in a limiting sense.

What is claimed is:

1. A water electrolysis apparatus comprising:
a solid electrolyte film configured to include a first surface and a second surface opposite side of said first surface;
an anode configured to be provided to contact with said first surface in a first surface side;
a cathode configured to be provided to be separated from said second surface in a second surface side; and
a flow path configured to be provided between said second surface and said cathode,
wherein water can flow through said anode, and
wherein electrolytic solution can flow through said flow path.

2. The water electrolysis apparatus according to claim 1, wherein a distance between said second surface and said cathode is a distance which leads to a potential difference from 1/10 to 4 times of a potential difference generated between said first surface and said second surface of said solid electrolyte film.

3. The water electrolysis apparatus according to claim 1, wherein a pressure of said electrolytic solution in said second surface side is higher than a pressure of said water in said first surface side.

4. The water electrolysis apparatus according to claim 1, wherein said flow path includes:
a nonconductive member configured to be in contact with said second surface at one plane and be in contact with said cathode at the other plane,
wherein said electrolytic solution can flow through said nonconductive member.

5. The water electrolysis apparatus according to claim 4, wherein said nonconductive member is formed of nonconductive material including a porous body through which said electrolytic solution can flow.

6. The water electrolysis apparatus according to claim 4, wherein said nonconductive material includes a gel substance containing said electrolytic solution.

7. The water electrolysis apparatus according to claim 1, wherein said electrolytic solution includes aqueous solution containing salt between strong acid and alkali metal.

8. The water electrolysis apparatus according to claim 7, wherein said salt includes at least one of sodium chloride, sodium sulfate and sodium nitrate.

9. The water electrolysis apparatus according to claim 7, wherein said electrolytic solution further includes at least one of a chemical compound containing a thirteenth group element and a chemical compound containing a fifteenth group element.

10. The water electrolysis apparatus according to claim 7, wherein said electrolytic solution further includes acid forming a metal complex.

11. The water electrolysis apparatus according to claim 1, wherein said electrolytic solution includes one of ion liquid and a gel substance containing said ion liquid.

12. A water electrolysis system comprising:
a water supplying unit configured to supply water;
a electrolytic solution supplying unit configured to supply electrolytic solution; and
a water electrolysis apparatus configured to receive said water and said electrolytic solution and perform electrolysis of said water,
wherein said water electrolysis apparatus includes:
a solid electrolyte film configured to include a first surface and a second surface opposite side of said first surface,
an anode configured to be provided to contact with said first surface in a first surface side,
a cathode configured to be provided to be separated from said second surface in a second surface side, and
a flow path configured to be provided between said second surface and said cathode,
wherein said water can flow through said anode, and
wherein said electrolytic solution can flow through said flow path.

13. The water electrolysis system according to claim 12, wherein a distance between said second surface and said cathode is a distance which leads to a potential difference from 1/10 to 4 times of a potential difference generated between said first surface and said second surface of said solid electrolyte film.

14. The water electrolysis system according to claim 12, wherein a pressure of said electrolytic solution in said second surface side is higher than a pressure of said water in said first surface side.

15. The water electrolysis system according to claim 12, wherein said flow path includes:
a nonconductive member configured to be in contact with said second surface at one plane and be in contact with said cathode at the other plane,
wherein said electrolytic solution can flow through said nonconductive member.

16. The water electrolysis system according to claim 15, wherein said nonconductive member is formed of nonconductive material including a porous body through which said electrolytic solution can flow.

17. The water electrolysis system according to claim 12, wherein said electrolytic solution includes aqueous solution containing salt between strong acid and alkali metal.

18. The water electrolysis system according to claim 17, wherein said electrolytic solution further includes at least one of a chemical compound containing a thirteenth group element and a chemical compound containing a fifteenth group element.

19. A water electrolysis method comprising:
supplying water to an anode provided to contact with a first surface of a solid electrolyte film, wherein said water flows through said anode;
supplying electrolytic solution between a cathode provided to be separated from a second surface of said solid electrolyte film and said second surface; and
applying a direct current power between said anode and said cathode.

20. A solid polymer fuel cell comprising:
a solid electrolyte film configured to include a first surface and a second surface opposite side of said first surface;
an anode configured to be provided to contact with said first surface in a first surface side;
a cathode configured to be provided to be separated from said second surface in a second surface side; and
a flow path configured to be provided between said second surface and said cathode,
wherein fuel can flow through said anode, and wherein oxidant and electrolytic solution can flow through said flow path.
